(19) United States
(12) Patent Application Publication
(10) Pub. No.: US 2012/0073338 A1
(43) Pub. Date: Mar. 29, 2012

(54) Intelligent Automated Deadbolt

(75) Inventor: Dave Mohla, Seattle, WA (US)

(73) Assignee: Dave Mohla, Seattle, WA (US)

(21) Appl. No.: 12/889,326

(22) Filed: Sep. 23, 2010

(51) Int. Cl. E05B 47/00; G05B 19/00; E05B 65/06

(52) U.S. Cl. 70/124; 70/280; 340/5.64

(57) ABSTRACT

A deadbolt that automatically locks based on the location of a key fob that is in a user's possession. The deadbolt automatically unlocks whenever the key fob is within a designated distance from the deadbolt and automatically locks when the key fob is past a designated distance from the deadbolt. Additionally, a key can be used to manually unlock the deadbolt at anytime and the deadbolt can be switched to manual mode so it functions like a traditional deadbolt.

### BACKGROUND OF THE INVENTION

Deadbolts are used on doors to prevent intruders from entering a home. Three main types of deadbolts exist on the market as current art: 1) a traditional mechanical deadbolt that requires a key to be entered and then turned to lock and unlock the deadbolt, 2) an electronic card deadbolt that requires a thin plastic card to be entered in and pulled out to unlock the deadbolt, and 3) an electronic keypad deadbolt that requires a numeric pass code to be entered to unlock the deadbolt.

The problem with existing deadbolts is that they require time and effort to lock and unlock the door and are inconvenient for the user. The traditional mechanical deadbolt and electronic card deadbolt require a key or card to be inserted to unlock the deadbolt while the electronic keypad deadbolt requires a pass code to be remembered. To exacerbate the problems, both the electronic card and electronic keypad deadbolts automatically lock when a door is closed so there is risk of the user being accidentally locked out. And with the traditional deadbolt which doesn't automatically lock, there is a risk of accidentally leaving the door unlocked, thereby allowing an intruder to get in.

### BRIEF SUMMARY OF THE INVENTION

The invention solves this problem by automatically locking and unlocking the deadbolt based on the location of a key fob. When the user approaches a door the deadbolt automatically unlocks since the key fob is a short distance away from the deadbolt. Alternatively, when the user walks away from the door, the deadbolt automatically locks since the key fob is past a designated distance from the deadbolt. Additionally, the deadbolt can be set to manual mode and can be locked and unlocked using a traditional deadbolt key or knob. Furthermore, at anytime, a traditional key that's attached to the key fob can be used to manually unlock and lock the deadbolt in case any of the batteries are running low. Finally, the invention uses standard deadbolt holes and doesn't require any special holes or cutouts to be made on the door.

The invention is unique since it uses the key fob location to determine whether to lock or unlock the door and eliminates the need for a key, card, or pass code to be entered into the deadbolt, thereby reducing the time and effort to lock and unlock it. This increases its convenience since locking and unlocking is done automatically and intelligently. Additionally, the deadbolt eliminates the risk of being locked out since the deadbolt will not unlock to let the user out of the home if he does not have the key fob in his possession. Finally, the deadbolt eliminates the risk of accidentally leaving the door unlocked when entering or leaving since it automatically locks when the key fob is a designated distance away from the deadbolt.

### BRIEF DESCRIPTION OF THE DRAWINGS

FIG. 1 is a front perspective view of the deadbolt;

FIG. 2 is a back perspective view of the deadbolt;

FIG. 3 is a front view of the deadbolt;

FIG. 4 is a back view of the deadbolt;

FIG. 5 is a front view of the deadbolt with the housing and battery cover removed;

FIG. 6 is a front perspective view of the deadbolt with the housing and battery cover removed;

FIG. 7 is a back perspective view of the deadbolt with the housing and battery cover removed;

FIG. 8 is a front perspective view of the key fob;

FIG. 9 is a front view of the key fob;

FIG. 10 is a back view of the key fob;

FIG. 11 is a back perspective view of the key fob with the cover removed;

FIG. 12 is a front perspective view of the key fob with the case removed;

FIG. 13 is a logic diagram depicting how the deadbolt functions.

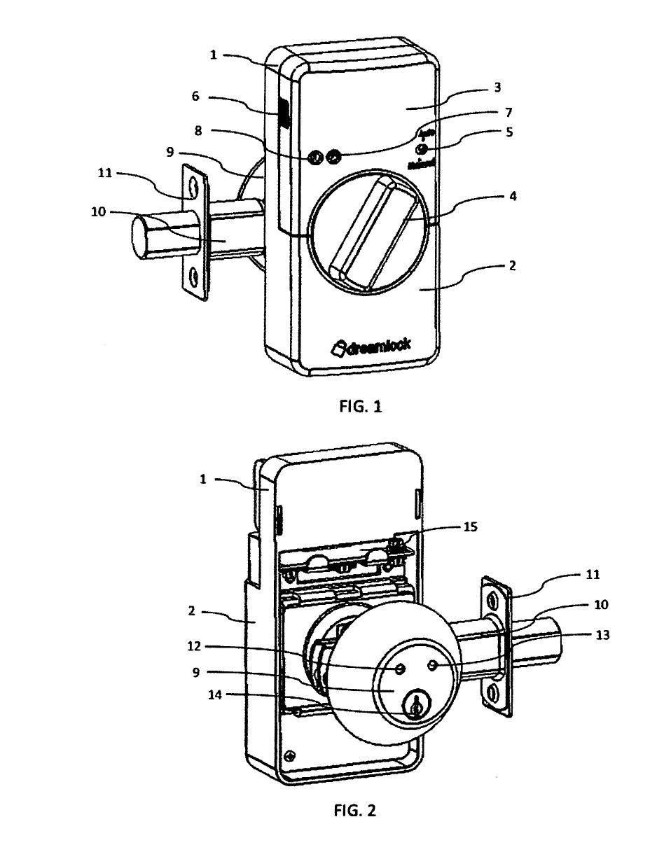

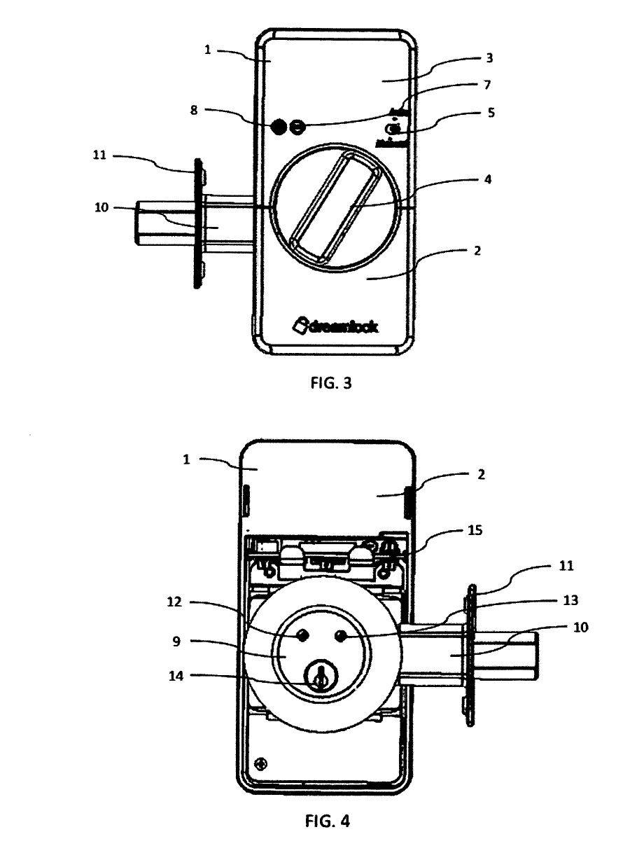

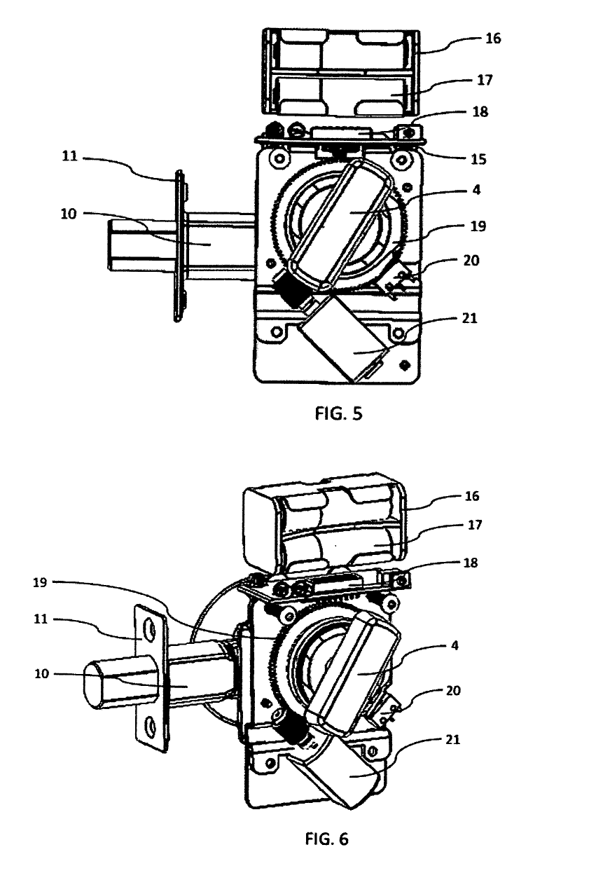

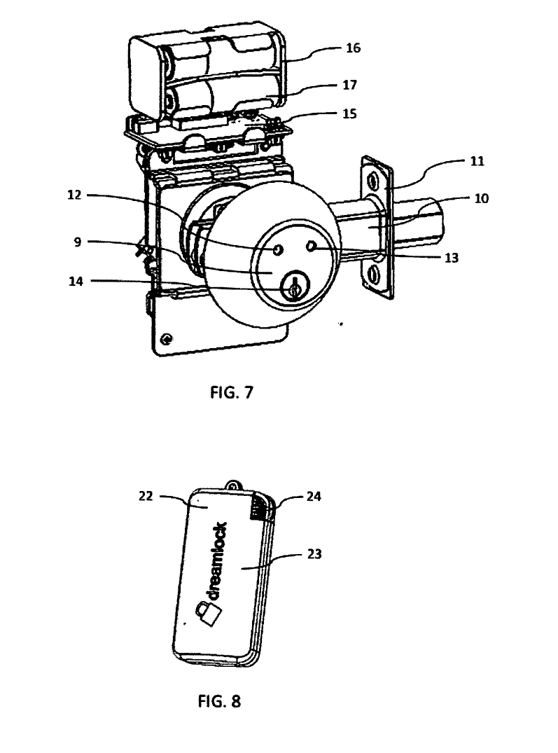

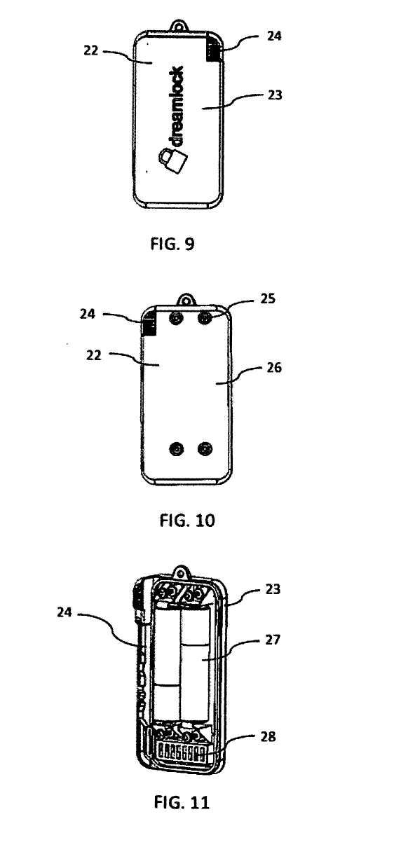

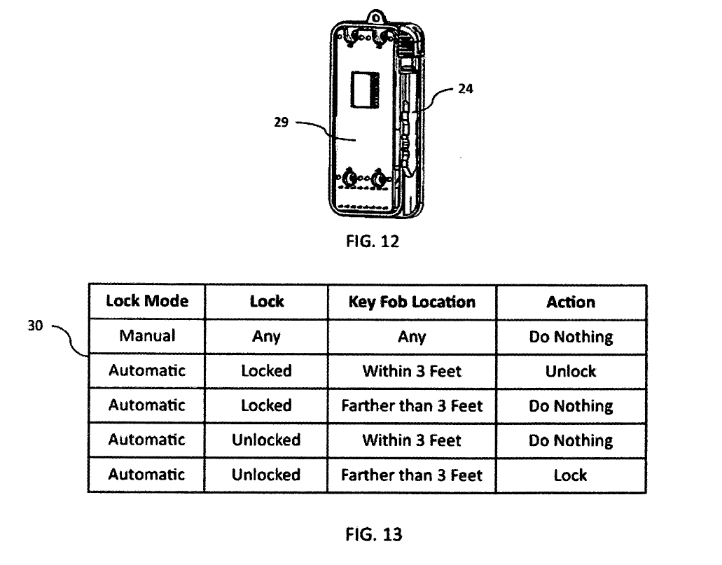

The following parts compose the preferred embodiment of the invention and are pointed out in the drawings.

| Part Number | Part Name |
|---|---|
| 1 | Deadbolt |
| 2 | Housing |
| 3 | Battery Cover |
| 4 | Knob |
| 5 | Mode Switch |
| 6 | Release Latch |
| 7 | Inside Locked Light |
| 8 | Inside Unlocked Light |
| 9 | Lock |
| 10 | Latch Assembly |
| 11 | Strike Plate |
| 12 | Outside Locked Light |
| 13 | Outside Unlocked Light |
| 14 | Lock Keyhole |
| 15 | Circuit Board |
| 16 | Battery Holder |
| 17 | Batteries |
| 18 | Code Changer |
| 19 | Gear |
| 20 | Lock Position Sensor |
| 21 | Motor |
| 22 | Key Fob |
| 23 | Case |
| 24 | Key |
| 25 | Screws |
| 26 | Cover |
| 27 | Key Fob Battery |
| 28 | Key Fob Code Changer |
| 29 | Key Fob Circuit Board |
| 30 | Circuit Board Logic Diagram |

### DETAILED DESCRIPTION OF THE INVENTION

Deadbolt 1 attaches to a door using standard deadbolt holes found on a typical residential door. Deadbolt 1 automatically unlocks when a user has key fob 22 and approaches the door that has deadbolt 1 installed and automatically locks when a user has key fob 22 and moves away from the door. Additionally, deadbolt 1 can be set to manual mode using mode switch 5 where it does not automatically lock or unlock and instead requires knob 4 or lock 9 to be manually turned to lock or unlock deadbolt 1.

To achieve this intelligence, deadbolt 1 has a circuit board 15 that takes inputs from mode switch 5 on whether the mode has been set to automatic or manual, from lock position sensor 20 on whether deadbolt 1 is locked or unlocked, and from the transmitter on key fob circuit 29 on whether key fob 22 is located within a select distance from deadbolt 1. When mode switch 5 is set to manual mode, circuit board 15 does not send any signals to motor 21 and so knob 4 can be turned horizontal to lock deadbolt 1 and can turned vertical to unlock deadbolt 1. When mode switch 5 is set to automatic mode and deadbolt 1 is locked based on lock position sensor 20 and key fob 22 is located within a select distance from deadbolt 1 then circuit board 15 sends a signal to motor 21 to unlock deadbolt 1. When mode switch 5 is set to automatic mode and deadbolt 1 is unlocked based on lock position sensor 20 and key fob 22 is located beyond a select distance from deadbolt 1 then circuit board 15 sends a signal to motor 21 to lock deadbolt 1. Circuit board logic diagram 30 describes the action that circuit board 15 takes based on the inputs from mode switch 5, lock position sensor 20, and key fob 22. It assumes that the designated distance for key fob 22 to lock and unlock deadbolt 1 is 3 feet.

To lock and unlock deadbolt 1, motor 21 turns gear 19 which is attached to latch assembly 10. To lock deadbolt 1, motor 21 turns and pushes the latch out of latch assembly 10 so it's inserted through strike plate 11 which is attached to the door trim, thereby preventing the door from opening. To unlock deadbolt 1, motor 21 turns and pulls the latch in from latch assembly 10 so the latch is no longer inserted through strike plate 11, thereby allowing the door to open. When deadbolt 1 is locked, circuit board 15 sends a signal to inside locked light 7 and outside locked light 12 to turn on for a short period of time to notify the user that deadbolt 1 has been locked. When the latch is unlocked, circuit board 15 sends a signal to inside unlocked light 8 and outside unlocked light 13 to turn on for a short period of time to notify the user that deadbolt 1 has been unlocked.

Batteries 17 are located in battery holder 16 and can be accessed by pressing release latch 6 and then pulling out battery cover 3. Batteries 17 power circuit board 15, motor 21, lock position sensor 20, inside locked light 7, inside unlocked light 8, outside locked light 12, and outside unlocked light 13.

At anytime, key 24 can be entered into lock 9 and used to manually lock and unlock deadbolt 1. This functions the same as a traditional deadbolt and is useful if batteries 17 or fob battery 27 are low causing deadbolt 1 to not automatically lock or unlock.

Key fob 22 consists of key 24 and can be attached to any standard key ring. Key 24 can be pulled out of case 23. Key 24 can then be used to lock and unlock deadbolt 1 by inserting key 24 into lock 9. Key 24 can be inserted back into case 23.

Key fob 22 contains a transmitter that is part of key fob circuit board 29 and is powered by key fob battery 27. Key fob circuit board 29 transmits a scrambled signal based on a unique code set in key fob code changer 28. The transmitted signal is then picked up by a receiver on circuit board 15 on deadbolt 1 and used to determine the distance of key fob 22 from deadbolt 1. The code transmitted from fob circuit board 29 must match the code set in code changer 18 for the signal to be acknowledged. This ensures that only designated key fobs 22 can lock and unlock deadbolt 1. A user can change the code transmitted from key fob 22 by rotating the number dials on fob code changer 28 or can change the code accepted by deadbolt 1 by rotating the number dials on code changer 18. This is useful if the user obtains a new key fob 22 and needs to program it to work with deadbolt 1. Key fob battery 27 and key fob code changer 28 can be accessed by removing screws 25 and pulling off cover 26.

What is claimed is:

1. A deadbolt that automatically unlocks when a key fob is within a designated distance from the deadbolt. The key fob can be any device with a battery and microprocessor. This includes a small device attached to a key ring or a cell phone or personal digital assistant (PDA).

2. A deadbolt that automatically locks when a key fob is past a designated distance from the deadbolt.

3. The system according to claims 1 and 2 that has a manual lock whereby a key can be inserted into such lock and then turned to manually unlock the deadbolt.

4. The system according to claims 1 and 2 that has a manual mode. When the deadbolt is switched to manual mode the deadbolt no longer automatically locks and unlocks based on the key fob location and instead requires a key to be entered into the lock in order to lock or unlock it from the outside or requires a knob to be turned on the inside of the deadbolt to lock or unlock it.

5. The system according to claims 1 and 2 that uses a unique code that is located on both the deadbolt and key fob that must match in order to lock and unlock the deadbolt. Code changers are located on both the deadbolt and key fob and allow the unique code on each device to be adjusted.

6. The system according to claims 1 and 2 that can be installed using standard deadbolt holes that are found on a door in a residential home.
